(19) United States
(12) Patent Application Publication
(10) Pub. No.: US 2015/0142679 A1
(43) Pub. Date: May 21, 2015

(54) PROVISIONING RULES TO MANAGE USER ENTITLEMENTS

(71) Applicant: Adobe Systems Incorporated, San Jose, CA (US)

(72) Inventors: Vijay Ghaskadvi, San Jose, CA (US); Daniel C. Brotsky, Berkeley, CA (US); Cristian-Mihai Marin, Bucharest (RO); Shyama P. Padhi, Union City, CA (US); Kashyap Jogi, San Jose, CA (US); Guanshan Yu, San Jose, CA (US); David Pond, Morrison, CO (US)

(73) Assignee: Adobe Systems Incorporated, San Jose, CA (US)

(21) Appl. No.: 14/081,193

(22) Filed: Nov. 15, 2013

(51) Int. Cl. G06Q 30/00

(52) U.S. Cl. CPC G06Q 30/018
USPC 705/317

(57) ABSTRACT

In techniques for provisioning rules to manage user entitlements, a database maintains an association of a user identifier with one or more purchased entitlements that correspond to products or services purchased by a consumer entity from one or more service groups. An entitlement manager is implemented to receive provisioning rules that have been designated by the service groups to designate fulfillable entitlements that are associated with the purchased entitlements. The entitlement manager also utilizes a multi-dimensional vector space technique to generate an entitlement model that relates the purchased entitlements of the consumer entity, correlates the fulfillable entitlements for the purchased entitlements, and identifies resultant allocations of the fulfillable entitlements for the consumer entity.

### BACKGROUND

Many companies have, or are beginning to develop, products and services that are offered and/or managed as an on-line subscription, such as a software application that may be accessed on-line through a service provider and application interface, or downloaded as a device application that communicates with the service provider for on-line updates and management of the application. Products, such as software applications, can be offered as subscriptions, and each subscription entitles a user to one or more specific entitlements, such as a one-year license to use the software application, as well as a certain amount of central data storage space, or other entitlements. Problems with allocating and managing the entitlements can arise when an individual user or a business organization has multiple overlapping subscriptions, which then entitles the consumer entity to various, multiple associated entitlements and/or conflicting entitlements.

### SUMMARY

This Summary introduces features and concepts of provisioning rules to manage user entitlements, which is further described below in the Detailed Description and/or shown in the Figures. This Summary should not be considered to describe essential features of the claimed subject matter, nor used to determine or limit the scope of the claimed subject matter.

Provisioning rules to manage user entitlements are described. In embodiments, a database maintains an association of a user identifier with one or more purchased entitlements that correspond to products or services purchased by a consumer entity from one or more service groups. An entitlement manager is implemented to receive provisioning rules that have been designated by the service groups to designate fulfillable entitlements that are associated with the purchased entitlements. The entitlement manager also utilizes a multi-dimensional vector space technique to generate an entitlement model that relates the purchased entitlements of the consumer entity, correlates the fulfillable entitlements for the purchased entitlements, and identifies resultant allocations of the fulfillable entitlements for the consumer entity.

In implementations, each of the service groups define the fulfillable entitlements for their respective products or services, and generate the provisioning rules. Each of the purchased entitlements can be modeled as a point in the multi-dimensional vector space, and each of the purchased entitlements are definable by a set of the fulfillable entitlements. A provisioning function of the multi-dimensional vector space can be applied to determine the resultant allocations of the fulfillable entitlements for the consumer entity, as designated in the entitlement model.

In implementations, the entitlement manager can merge similar fulfillable entitlements that correspond to more than one of the purchased entitlements to develop the entitlement model. The entitlement manager can merge the similar fulfillable entitlements by one of adding the similar fulfillable entitlements, deleting at least one of the similar fulfillable entitlements, or organizing the similar fulfillable entitlements as a single fulfillable entitlement for the consumer entity. The entitlement manager can also generate notifications for a consumer entity and/or for the service groups, where the notifications are generated based on the resultant allocations of the fulfillable entitlements for the consumer entity.

In implementations, the entitlement manager can receive re-provisioned rules from one of the service groups to alter the fulfillable entitlements that are associated with a purchased entitlement, and then generate an update to the entitlement model for the consumer entity based on the re-provisioned rules. The entitlement manager can also receive a granted entitlement that is allocated to the consumer entity, where the granted entitlement overrides one or more of the fulfillable entitlements that are associated with a purchased entitlement. The entitlement manager can then generate an update to the entitlement model for the consumer entity based on the granted entitlement.

### BRIEF DESCRIPTION OF THE DRAWINGS

Embodiments of provisioning rules to manage user entitlements are described with reference to the following Figures. The same numbers may be used throughout to reference like features and components that are shown in the Figures:

FIG. 1 illustrates an example system in which embodiments of provisioning rules to manage user entitlements can be implemented.

FIG. 2 illustrates an example of an entitlement model that correlates fulfillable entitlements with purchased entitlements, and resultant allocations of the fulfillable entitlements in accordance with one or more embodiments of provisioning rules to manage user entitlements.

FIG. 3 illustrates example method(s) of provisioning rules to manage user entitlements in accordance with one or more embodiments.

FIG. 4 illustrates an example system with an example device that can implement embodiments of provisioning rules to manage user entitlements.

### DETAILED DESCRIPTION

Embodiments of provisioning rules to manage user entitlements are described and may be implemented by a service provider to aggregate individual fulfillable entitlements that are associated with multiple purchased entitlements, such as when a consumer entity purchases an on-line product or service. A consumer entity may be an individual customer, a group of individuals, or an organization that purchases an on-line product, such as a software application. A purchased entitlement is a collection of one or more individual entitlements, such as the ability to use the software application as a desktop product and have access to a designated amount of cloud storage space for a duration of time, such as for one month or a year. A fulfillable entitlement represents one of the individual entitlements that a customer is entitled to and its associated quantity, such as an allocation of five gigabytes (5 GB) of the cloud storage space, or use of the software application for the period of one year.

Provisioning rules to manage user entitlements can be implemented to manage the various, multiple associated fulfillable entitlements when a consumer entity has multiple overlapping subscriptions for purchased entitlements. For example, a consumer entity may have three different product subscriptions that each offers ten gigabytes (10 GB) of storage space. A union set of all the different entitlements can be determined, where the union is entitlement-specific and each entitlement is evaluated separately depending on the associated provisioning rules for each of the entitlements. An entitlement manager is implemented to determine the new quantities of each of the entitlements, and provision them accordingly. The entitlement manager also manages any changes, updates, and additions to the set of purchased entitlements for a consumer entity, as well as to the provisioning rules that are implemented to convert the subscription information based on lifecycle events and used to manage the net fulfillable entitlements for a consumer entity.

While features and concepts of provisioning rules to manage user entitlements can be implemented in any number of different devices, systems, networks, environments, and/or configurations, embodiments of provisioning rules to manage user entitlements are described in the context of the following example devices, systems, and methods.

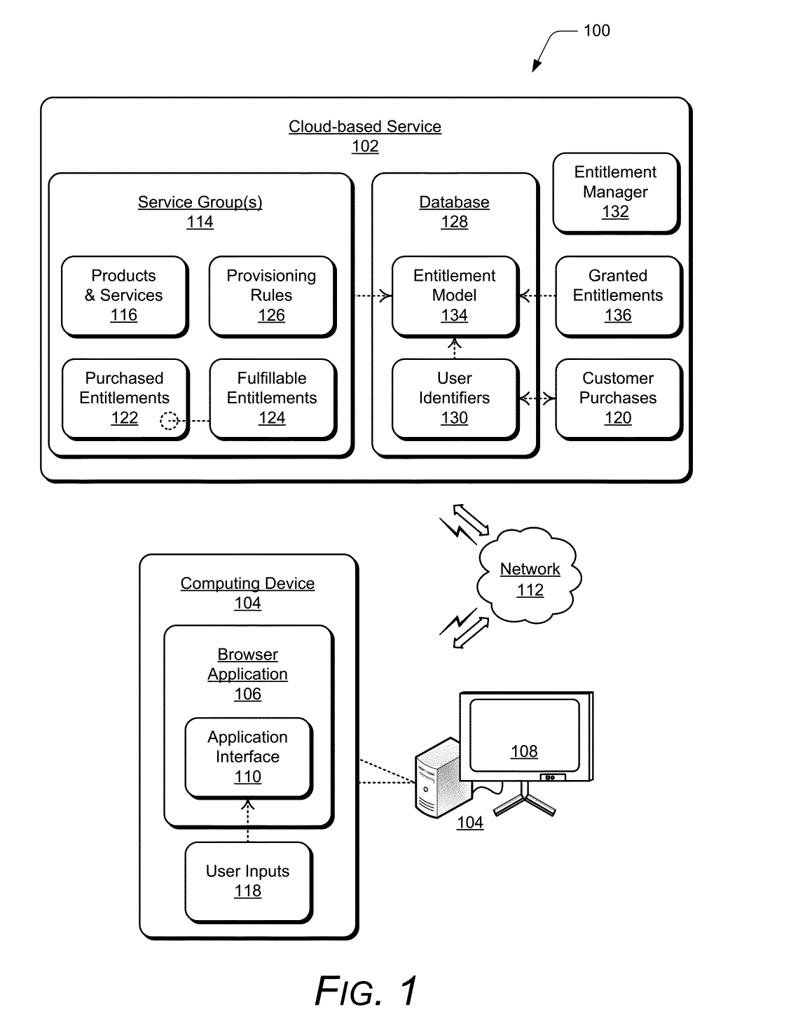

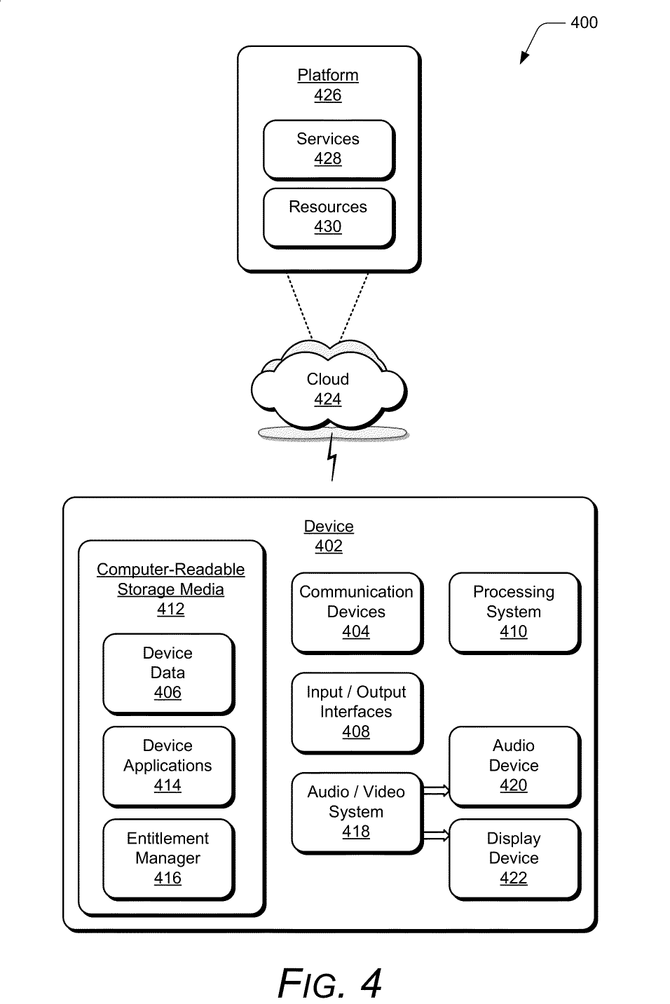

FIG. 1 illustrates an example system 100 in which embodiments of provisioning rules to manage user entitlements can be implemented. The example system 100 includes a cloud-based service 102 that a user can access via a computing device 104, such as any type of portable or desktop computer, mobile phone, tablet device, and/or other type of computing device. The computing device 104 can be implemented with a browser application 106 through which a user can access the service 102, such as to purchase and/or use on-line provided products and services. A computing system may include a display device 108 that is connected to the computing device 104, such as to display a browser interface and/or an application interface 110. Additionally, the computing device 104 can be implemented with various components, such as a processing system and memory, and with any number and combination of differing components as further described with reference to the example device shown in FIG. 4.

Any of the devices, data servers, and networked services described herein can communicate via a network 112, which can be implemented to include a wired and/or a wireless network. The network can also be implemented using any type of network topology and/or communication protocol, and can be represented or otherwise implemented as a combination of two or more networks, to include IP-based networks and/or the Internet. The network may also include mobile operator networks that are managed by a mobile network operator and/or other network operators, such as a communication service provider, mobile phone provider, and/or Internet service provider.

In this example system 100, the cloud-based service 102 includes one or more service groups 114 from which a user can purchase and/or use the on-line provided products and services 116. The service 102 and/or the service groups 114 can receive user inputs 118, such as when a user at the computing device 104 initiates a user input with a computer input device to purchase and/or use the on-line provided products and services 116. The computing device 104 communicates the user inputs 118 to the service 102 via the network 112, and the service 102 and the service groups 114 track the customer purchases 120.

The products and services 116 that are offered by the service groups 114 can include desktop applications, on-line application access, and any other type of products and/or services that a user may purchase and access, such as from the computing device 104. For example, a consumer entity, such as an individual customer, a group of individuals, or an organization, may purchase use of a software application from a software provider, such as when a customer buys a software product as an on-line service for a term of one year. The customer may then interface with the software application on-line, such as through the application interface 110 in the browser application 106, or the software application may be installed locally on the computing device 104 as a desktop application that is designed to communicate with a backend on-line service as the customer uses the product.

In embodiments, a customer purchase 120 of a product or service by a consumer entity is a purchased entitlement 122 that has associated fulfillable entitlements 124. A purchased entitlement 122 is a collection of one or more individual entitlements, such as the ability to use the software application as a desktop product and have access to a designated amount of cloud storage space. The fulfillable entitlements 124 each represent one of the individual entitlements that a customer is entitled to and its associated quantity, such as an allocation of five gigabytes (5 GB) of the cloud storage space, and use of the software application for one year.

Each of the service groups 114 can establish and implement provisioning rules 126 that indicate how to manage the various, multiple associated fulfillable entitlements 124 when a consumer entity has multiple overlapping subscriptions for purchased entitlements 122. For example, a consumer entity may have three different product subscriptions that each offers ten gigabytes (10 GB) of storage space. It may be determined from the provisioning rules 126 that a customer should not exceed ten gigabytes (10 GB) of storage space, regardless of the number of purchased entitlements. In implementations, the provisioning rules can be generated and received from the service groups 114 in a common programmed format that can be compiled by the entitlement manager to combine and dynamically update the provisioning rules from all of the service groups.

The cloud-based service 102 can include data servers that communicate data to computing devices via the network 112, and the data servers maintain a database 128 (or databases) implemented in any suitable memory, memory device, or electronic data storage for network-based data storage. The database 128 maintains user identifiers 130 that correlate to identify the consumer entities for the customer purchases 120, where a consumer entity is a customer that is associated with a user identity, or with any other customer characteristic or identifier. The customer purchases 120 are associated with the purchased entitlements 122 and the fulfillable entitlements 124 for the products and/or services 116 that are purchased from the service groups 114. Further, the service 102 can include any server devices and applications, and can be implemented with various components, such as a processing system and memory, as well as with any number and combination of differing components as further described with reference to the example device shown in FIG. 4.

The cloud-based service 102 includes an entitlement manager 132, such as a software application (e.g., executable instructions) that is executable with a processing system to implement embodiments of provisioning rules to manage user entitlements. The entitlement manager 132 can be stored on a computer-readable storage memory, such as any suitable memory, storage device, or electronic data storage implemented at the service 102 and/or by the service groups 114. In embodiments, the entitlement manager 132 is implemented to generate and manage an entitlement model 134 that can also be maintained in the database 128 at the cloud-based service 102.

The entitlement manager 132 can generate the entitlement model 134 as an implementation of a provisioning function, which is based on the provisioning rules 126 from each of the service groups 114, as well as the purchased entitlements 122 and the associated fulfillable entitlements 124. The entitlement manager 132 also correlates the user identifiers 130 that correspond to the customer purchases 120, such as for the consumer entities of the products and services 116, and a user identifier 130 correlates with a purchased entitlement 122 for a consumer entity. The entitlement manager 132 can also generate the entitlement model 134 based on granted entitlements 136, which may be initiated as an entitlement override, such as when a granted entitlement is allotted independent of customer purchases by a customer service representative as a make good on a purchase or for a customer special need.

In embodiments, the entitlement manager 132 can model each of the service groups 114 as a vector space, and the fulfillable entitlements 124 for a particular purchased entitlement 122 can have a number of dimensions, which are the parameters that can be set on the service. Each fulfillable entitlement 124 can then be designated as a point in the vector space of a service group. The entitlement manager 132 can apply a provisioning function to combine multiple purchased entitlements and sort out allocation of the associated fulfillable entitlements. The fulfillable entitlements 124 for various consumer entities can be reduced to a transformative operation, implemented through external, editable code as the provisioning rules 126 for each of the service groups 114.

Implementations provide that a service group 114 can define purchasable entitlements 122 as sets of the fulfillable entitlements 124, allowing for the independent, specific provisioning rules 126 that can be designated, applied, and updated to handle overlapping subscriptions for consumer entities. The entitlement manager 132 receives the provisioning rules 126 from each respective service group, and computes the net fulfillable entitlements 124 that are associated with the purchased entitlements 122 for a consumer entity. The entitlement manager can also maintain and update the logic of the entitlement model 134 as each service group 114 updates respective provisioning rules 126 (e.g., re-provisions the rules), as may be representative of shifting business needs. For example, a service group 114 may change product entitlement definitions, even without a change in a user's purchased entitlements, and the entitlement manager 132 can update or regrant the net fulfillable entitlements for the entitlement model 134 based on the changes to the product entitlement definitions by the service group.

In implementations, a purchased entitlement 122 can be modeled as a vector in a specifically defined vector space, the axes of which represent the unique individual entitlements offered by the purchased entitlement, and the projections of the vector along each of the axes represent the quantity and/or parameters being offered for that entitlement. The products and services 116 that are offered by the service groups 114 can be evaluated for the net fulfillable entitlement values in order to enforce the business logic for the fulfillable entitlements 124. For example, a consumer entity can see how much cloud storage space has been allocated by looking up a single value for the storage fulfillable entitlement, as well as how much of the cloud storage space is currently being utilized. The entitlement manager 132 can also be implemented to take appropriate actions when necessary, such as to warn a user when he or she has exceeded a quota or capacity for the storage space. In implementations, the entitlement manager 132 can generate notifications that are communicated to the service groups and/or to a consumer entity, such as to warn a user that a product life-cycle will soon end without some action taken by the user to continue use of the product.

A provisioning function can be defined on a single purchased entitlement (PdE) 122, which is a function from one PdE to a set of n-fulfillable entitlements (FEs) 124. This provisioning function can be formed as a simple mapping in many cases, where the fulfillable entitlements 124 are mapped to specific values, such as in a lookup table or other relational data structure. The definition of the provisioning function can be extended to operate on the domain of a set of PdEs, resulting in a set m of FEs, as shown here in equation (1):

prov({PdE1,PdE2, . . . , PdEₙ})=>{FE1,FE2, . . . , FEₘ} (eq. 1)

The provisioning function (identified as “prov”) in the equation can be divided into individual functions to calculate each of the fulfillable entitlements (FEs) 124, as represented by the functions provFE1, provFE2, . . . , provFEₘ, where each of the functions are defined separately and the domain of purchased entitlements (PdEs) 122 that they operate on is potentially a different subset of the original set of PdEs. The subset that each of these functions can operate on will depend on whether a given purchased entitlement (PdE) configures the fulfillable entitlement (FE) in question. For example, if a fulfillable entitlement FE1 for cloud storage space is only associated with two purchased entitlements PdE1 and PdE4, then the provisioning function will be as shown here in equation (2):

provFE1({PdE1,PdE4})=>FE1 (eq. 2)

The individual provisioning functions can then be applied for each of the fulfillable entitlements (FEs). Combining the above two equations (eq. 1 and eq. 2), the provisioning function can be represented in the general form shown here in equation (3):

prov({PdE1,PdE2, . . . , PdEₙ})=>{provFE1({PdE1,PdE4}),

provFE2({PdEₓ,PdE_{y}, . . . }), . . . , provFEₘ({PdE_{z},PdEₖ, . . . })} (eq. 3)

The left side of this general form equation (eq. 3) is the overall provisioning processing that can be determined for a given consumer entity, and the right side of the general form equation (eq. 3) is implemented by the entitlement manager 132 when processing the combined logic of the provisioning rules 126 received from the service groups 114.

In implementations, the entitlement manager 132 can recompute the entitlement model 134 based on product license expirations, when a consumer entity purchases a new product or extends use of a currently licensed product, when a customer service representative initiates a granted entitlement 136, and/or for any other changes and inputs that alter the fulfillable entitlements 124 for a consumer entity. For example, the entitlement manager 132 can receive re-provisioned rules from one of the service groups 114 to alter the fulfillable entitlements 124 that are associated with the purchased entitlements 122, and then generate an update to the entitlement model 134 for the consumer entity based on the re-provisioned rules. The entitlement manager can also receive a granted entitlement 136 that is allocated to the consumer entity, where the granted entitlement overrides one or more of the fulfillable entitlements that are associated with a purchased entitlement. The entitlement manager can then generate an update to the entitlement model for the consumer entity based on the granted entitlement.

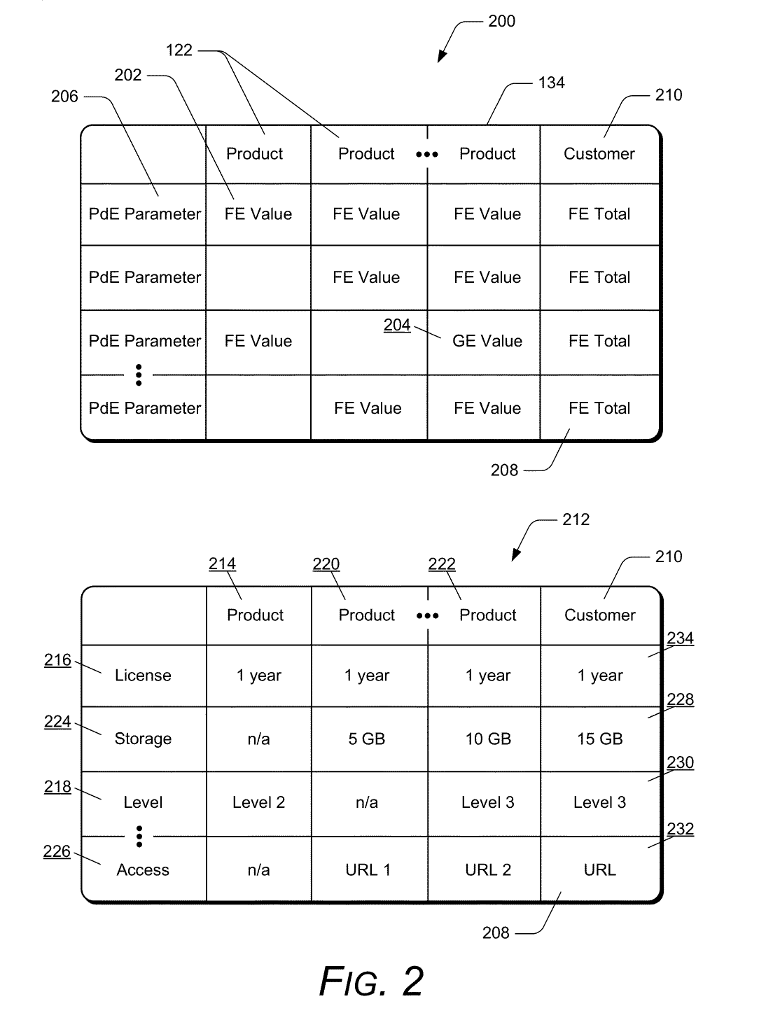

FIG. 2 illustrates an example 200 of the entitlement model 134 in a table representation that correlates values 202 of the fulfillable entitlements 124 and/or values 204 of a granted entitlement 136 for parameters 206 of the purchased entitlements 122, and resultant allocations 208 of the fulfillable entitlements for a consumer entity (e.g., a customer 210) in the entitlement model in accordance with one or more embodiments of provisioning rules to manage user entitlements. The purchased entitlements 122 (e.g., the products and/or services 116) are shown across the top of the table representation, and each column heading is a product purchased by the customer 210. The parameters 206 of the purchased entitlements 122 are shown as the row headings down the left side of the table representation. The value 202 of a fulfillable entitlement 124 is then correlated with a parameter 206 of a purchased entitlement 122 in the table representation of the entitlement model 134.

For example, as shown at 212, a product 214 has a license parameter 216 of one year, as designated by the value 202 of the fulfillable entitlement for the product purchased by the customer 210. The product 214 also has a level designation parameter 218 with a corresponding fulfillable entitlement value of “level2” for the customer. Additional products 220 and 222 also have the license parameter 216 of one year, as designated by the values 202 of the fulfillable entitlements for the products purchased by the customer 210. The product 220 also has a storage parameter 224 with the corresponding fulfillable entitlement value of five gigabytes (5 GB), and has an access designation parameter 226 with a corresponding fulfillable entitlement value of “URL1”, which may be a selectable link to the five gigabytes of storage space as designated by the storage parameter 224. The product 222 has the storage parameter 224 with the corresponding fulfillable entitlement value of ten gigabytes (10 GB), and has the access designation parameter 226 with a corresponding fulfillable entitlement value of “URL2”, which may be a selectable link to the ten gigabytes of storage space as designated by the storage parameter 224. The product 222 also has the level designation parameter 218, which is the granted entitlement value 204 of “level3” for the customer.

As described above with reference to FIG. 1, the entitlement manager 132 applies the provisioning function of the multi-dimensional vector space technique to determine the resultant allocations 208 of the fulfillable entitlements 124 for a consumer entity, as designated in the entitlement model 134. The entitlement manager 132 can merge similar fulfillable entitlements that correspond to more than one of the purchased entitlements 122. In implementations, the entitlement manager can merge similar fulfillable entitlements by adding the values 202 of the fulfillable entitlements. For example, the fulfillable entitlement value of five gigabytes (5 GB) that is associated with product 220 can be added to the fulfillable entitlement value of ten gigabytes (10 GB) that is associated with product 222 for a resultant allocation 228 of fifteen gigabytes (15 GB) of storage space for the customer 210.

The entitlement manager 132 can also be implemented to merge similar fulfillable entitlements by deleting one or more of the similar fulfillable entitlements. For example, the fulfillable entitlement value of “level2” that is associated with product 214 and the granted entitlement value of “level3” that is associated with product 222 are merged for a resultant allocation 230 of a “level3” value for all of the products (e.g., purchased entitlements 122) purchased by the customer 210. The fulfillable entitlement value of “level2” is effectively deleted. The entitlement manager 132 can also be implemented to merge similar fulfillable entitlements by organizing the similar fulfillable entitlements as a single fulfillable entitlement for the consumer entity. For example, the fulfillable entitlement values of “URL1” and “URL2” that are associated with respective products 220 and 222 can be merged or replaced as one resultant allocation 232 of just one URL that is selectable to access the fifteen gigabytes (15 GB) of storage space for the customer 210 (rather than the two URLs to the separate storage spaces associated with each of the different products). Similarly, the entitlement manager 132 merges the one year product licenses for each of the different products as one resultant allocation 234 of a one year license for all of the products (e.g., purchased entitlements 122) purchased by the customer 210.

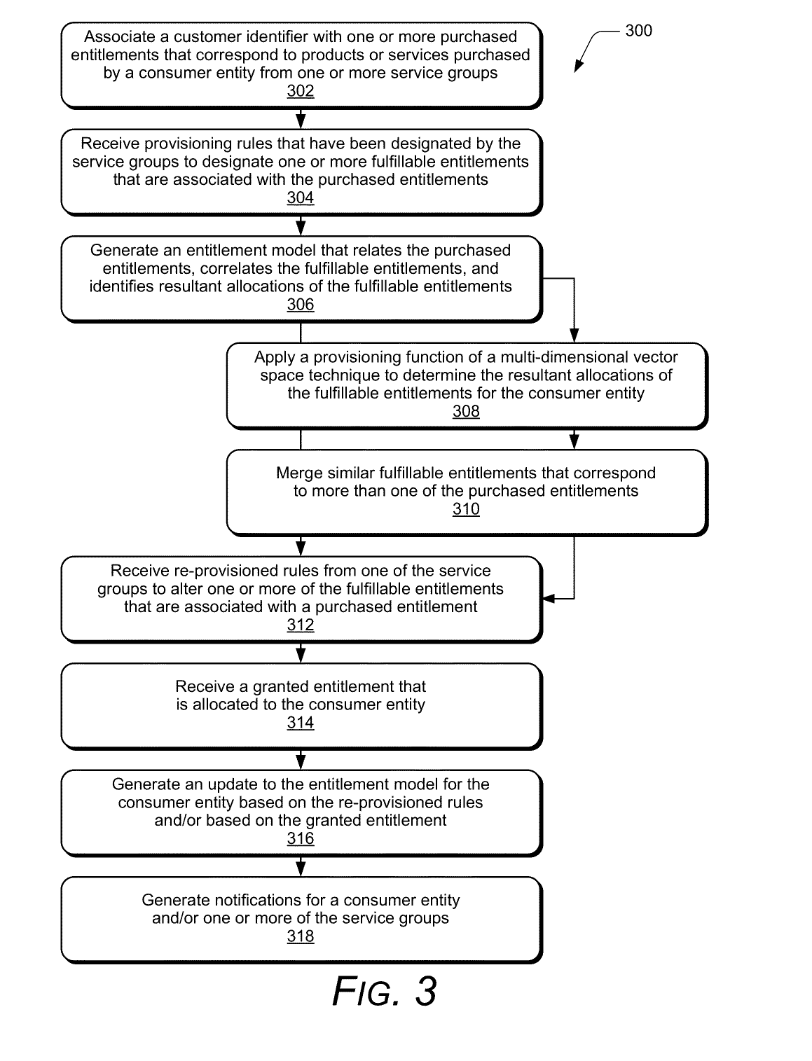

Example method 300 is described with reference to FIG. 3 in accordance with one or more embodiments of provisioning rules to manage user entitlements. Generally, any of the services, components, modules, methods, and operations described herein can be implemented using software, firmware, hardware (e.g., fixed logic circuitry), manual processing, or any combination thereof. The example methods may be described in the general context of executable instructions stored on computer-readable storage media that is local and/or remote to a computer processing system, and implementations can include software applications, programs, functions, and the like.

FIG. 3 illustrates example method(s) 300 of provisioning rules to manage user entitlements, and is generally described with reference to an entitlement manager. The order in which the method is described is not intended to be construed as a limitation, and any number or combination of the method operations can be combined in any order to implement a method, or an alternate method.

At 302, a user identifier is associated with one or more purchased entitlements that correspond to products or services purchased by a consumer entity from one or more service groups. For example, the entitlement manager 132 implemented at the cloud-based service 102 (FIG. 1) associates a user identifier 130 with purchased entitlements 122 that correspond to products or services 116 purchased by a consumer entity from one or more of the service groups 114.

At 304, provisioning rules are received that have been designated by the service groups to designate one or more fulfillable entitlements that are associated with the purchased entitlements. For example, the entitlement manager 132 receives the provisioning rules 126 from the service groups 114 that establish and implement the provisioning rules to designate the fulfillable entitlements 124 that are associated with the purchased entitlements 122.

At 306, an entitlement model is generated that relates the purchased entitlements of the consumer entity, correlates the fulfillable entitlements for the purchased entitlements, and identifies resultant allocations of the fulfillable entitlements for the consumer entity. For example, the entitlement manager 132 generates the entitlement model 134 that relates the purchased entitlements 122 of a consumer entity, correlates the fulfillable entitlements 124 for the purchased entitlements 122, and identifies the resultant allocations 208 (FIG. 2) of the fulfillable entitlements for the consumer entity (e.g., the customer 210 shown in FIG. 2).

Generating the entitlement model at 306 can include, at 308, a provisioning function of a multi-dimensional vector space technique applied to determine the resultant allocations of the fulfillable entitlements for the consumer entity, as designated in the entitlement model. For example, the entitlement manager 132 applies the provisioning function (identified as “prov” in eq. 3 above) of the multi-dimensional vector space technique to determine the resultant allocations 208 of the fulfillable entitlements 124 for the consumer entity, as designated in the entitlement model 134.

Generating the entitlement model at 306 can also include, at 310, similar fulfillable entitlements being merged, where the similar fulfillable entitlements correspond to more than one of the purchased entitlements. For example, the entitlement manager 132 merges similar fulfillable entitlements 124 that correspond to more than one of the purchased entitlements 122, where merging the similar fulfillable entitlements includes one of adding the similar fulfillable entitlements, deleting at least one of the similar fulfillable entitlements, or organizing the similar fulfillable entitlements as a single fulfillable entitlement for the consumer entity. Examples of merging the similar fulfillable entitlements are shown and described with reference to FIG. 2.

At 312, re-provisioned rules are received from one of the service groups to alter one or more of the fulfillable entitlements that are associated with a purchased entitlement. Similarly, at 314, a granted entitlement that is allocated to a consumer entity is received. For example, the entitlement manager 132 receives re-provisioned rules (e.g., updated provisioning rules 126) from one of the service groups 114 and/or a granted entitlement 136, such as an entitlement that overrides one or more of the fulfillable entitlements that are associated with a purchased entitlement.

At 316, an update to the entitlement model is generated for the consumer entity based on the re-provisioned rules and/or based on the granted entitlement. For example, the entitlement manager 132 generates an update to the entitlement model 134 for the consumer entity based on the re-provisioned rules that are received from one or more of the service groups 114 to alter the fulfillable entitlements 124 that are associated with the purchased entitlements 122, and/or based on the granted entitlement 136.

At 318, notifications are generated for at least one of the consumer entity and/or one or more of the service groups. For example, the entitlement manager 132 generates notifications that are communicated to the service groups 114 and/or to a consumer entity, such as to warn a user that a product life-cycle will soon end without some action taken by the user to continue use of the product. The notifications can be generated based on the resultant allocations 208 of the one or more fulfillable entitlements 124 for the consumer entity.

FIG. 4 illustrates an example system 400 that includes an example device 402, which can implement embodiments of provisioning rules to manage user entitlements. The example device 402 can be implemented as any of the devices and/or servers described with reference to the previous FIGS. 1-3, such as any type of client device, mobile phone, tablet, computing, communication, entertainment, gaming, media playback, and/or other type of device. For example, the computing device 104 and/or any computing devices of the cloud-based service 102 that implement the entitlement manager 132 shown in FIG. 1 may be implemented as the example device 402.

The device 402 includes communication devices 404 that enable wired and/or wireless communication of device data 406, such as media content, the provisioning rules, and entitlement model data that is collected and stored on the device. The media content can include any type of audio, video, and/or image data. The communication devices 404 can also include transceivers for cellular phone communication and for network data communication.

The device 402 also includes input/output (I/O) interfaces 408, such as data network interfaces that provide connection and/or communication links between the device, data networks, and other devices. The I/O interfaces can be used to couple the device to any type of components, peripherals, and/or accessory devices. The I/O interfaces also include data input ports via which any type of data, media content, and/or inputs can be received, such as user inputs to the device, as well as any type of audio, video, and/or image data received from any content and/or data source.

The device 402 includes a processing system 410 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 402 may further include any type of a system bus or other data and command transfer system that couples the various components within the device. A system bus can include any one or combination of different bus structures and architectures, as well as control and data lines.

The device 402 also includes computer-readable storage media 412, such as data storage devices that can be accessed by a computing device, and that provide persistent storage of data and executable instructions (e.g., software applications, programs, functions, and the like). Examples of computer-readable storage media include volatile memory and non-volatile memory, fixed and removable media devices, and any suitable memory device or electronic data storage that maintains data for computing device access. The computer-readable storage media can include various implementations of random access memory (RAM), read-only memory (ROM), flash memory, and other types of storage media in various memory device configurations.

The computer-readable storage media 412 provides storage of the device data 406 and various device applications 414, such as an operating system that is maintained as a software application with the computer-readable storage media and executed by the processing system 410. In this example, the device applications also include an entitlement manager 416 that implements embodiments of provisioning rules to manage user entitlements, such as when the example device 402 is implemented by the cloud-based service 102 shown in FIG. 1. An example of the entitlement manager 416 is the entitlement manager 132, as described with reference to FIGS. 1-3.

The device 402 can also include an audio and/or video system 418 that generates audio data for an audio device 420 and/or generates display data for a display device 422. The audio device and/or the display device include any devices that process, display, and/or otherwise render audio, video, display, and/or image data. In implementations, the audio device and/or the display device are integrated components of the example device 402. Alternatively, the audio device and/or the display device are external, peripheral components to the example device.

In embodiments, at least part of the techniques described for provisioning rules to manage user entitlements may be implemented in a distributed system, such as over a “cloud” 424 in a platform 426. The cloud 424 includes and/or is representative of the platform 426 for services 428 and/or resources 430. For example, the services 428 may include the cloud-based service 102 described with reference to FIG. 1. Additionally, the resources 430 may include the version of the entitlement manager 132 implemented by the cloud-based service as described with reference to FIG. 1.

The platform 426 abstracts underlying functionality of hardware, such as server devices (e.g., included in the services 428) and/or software resources (e.g., included as the resources 430), and connects the example device 402 with other devices, servers, etc. The resources 430 may also include applications and/or data that can be utilized while computer processing is executed on servers that are remote from the example device 402. Additionally, the services 428 and/or the resources 430 may facilitate subscriber network services, such as over the Internet, a cellular network, or Wi-Fi network. The platform 426 may also serve to abstract and scale resources to service a demand for the resources 430 that are implemented via the platform, such as in an interconnected device embodiment with functionality distributed throughout the system 400. For example, the functionality may be implemented in part at the example device 402 as well as via the platform 426 that abstracts the functionality of the cloud 424.

Although embodiments of provisioning rules to manage user entitlements have been described in language specific to features and/or methods, the appended claims are not necessarily limited to the specific features or methods described. Rather, the specific features and methods are disclosed as example implementations of provisioning rules to manage user entitlements.

1. A system, comprising:
a database configured to maintain an association of a user identifier with one or more purchased entitlements that correspond to products or services purchased by a consumer entity from one or more service groups;
a processor to implement an entitlement manager that is configured to:
receive provisioning rules that have been designated by the one or more service groups to designate one or more fulfillable entitlements that are associated with the purchased entitlements; and
utilize a multi-dimensional vector space technique to generate an entitlement model that relates the purchased entitlements of the consumer entity, correlates the one or more fulfillable entitlements for the purchased entitlements, and identifies resultant allocations of the one or more fulfillable entitlements for the consumer entity.

2. A system as recited in claim 1, wherein each of the service groups define the fulfillable entitlements for their respective products or services, and generate the provisioning rules.

3. A system as recited in claim 1, wherein a provisioning function of the multi-dimensional vector space technique is applied to determine the resultant allocations of the one or more fulfillable entitlements for the consumer entity, as designated in the entitlement model.

4. A system as recited in claim 1, wherein each of the purchased entitlements are modeled as a point in the multi-dimensional vector space, and each of the purchased entitlements are definable by a set of the one or more fulfillable entitlements.

5. A system as recited in claim 1, wherein the entitlement manager is configured to merge similar ones of the fulfillable entitlements that correspond to more than one of the purchased entitlements.

6. A system as recited in claim 5, wherein said merge the similar ones of the fulfillable entitlements includes the entitlement manager configured to one of add the similar fulfillable entitlements, delete at least one of the similar fulfillable entitlements, or organize the similar fulfillable entitlements as a single fulfillable entitlement for the consumer entity.

7. A system as recited in claim 1, wherein the entitlement manager is configured to:
receive re-provisioned rules from one of the service groups to alter the one or more fulfillable entitlements that are associated with a purchased entitlement; and
generate an update to the entitlement model for the consumer entity based on the re-provisioned rules.

8. A system as recited in claim 1, wherein the entitlement manager is configured to:
receive a granted entitlement that is allocated to the consumer entity, the granted entitlement overriding one or more of the fulfillable entitlements that are associated with a purchased entitlement; and
generate an update to the entitlement model for the consumer entity based on the granted entitlement.

9. A system as recited in claim 1, wherein
the entitlement manager is configured to generate notifications for at least one of the consumer entity and one or more of the service groups, the notifications generated based on the resultant allocations of the one or more fulfillable entitlements for the consumer entity.

10. A method, comprising:
associating a user identifier with one or more purchased entitlements that correspond to products or services purchased by a consumer entity from one or more service groups;
receiving provisioning rules that have been designated by the one or more service groups to designate one or more fulfillable entitlements that are associated with the purchased entitlements; and
generating an entitlement model that relates the purchased entitlements of the consumer entity, correlates the one or more fulfillable entitlements for the purchased entitlements, and identifies resultant allocations of the one or more fulfillable entitlements for the consumer entity.

11. A method as recited in claim 10, further comprising:
applying a provisioning function of a multi-dimensional vector space technique to determine the resultant allocations of the one or more fulfillable entitlements for the consumer entity, as designated in the entitlement model.

12. A method as recited in claim 10, further comprising:
merging similar ones of the fulfillable entitlements that correspond to more than one of the purchased entitlements.

13. A method as recited in claim 12, wherein said merging comprises one of:
adding the similar fulfillable entitlements;
deleting at least one of the similar fulfillable entitlements; or
organizing the similar fulfillable entitlements as a single fulfillable entitlement for the consumer entity.

14. A method as recited in claim 10, further comprising:
receiving re-provisioned rules from one of the service groups to alter the one or more fulfillable entitlements that are associated with a purchased entitlement; and
generating an update to the entitlement model for the consumer entity based on the re-provisioned rules.

15. A method as recited in claim 10, further comprising:
receiving a granted entitlement that is allocated to the consumer entity, the granted entitlement overriding one or more of the fulfillable entitlements that are associated with a purchased entitlement; and
generating an update to the entitlement model for the consumer entity based on the granted entitlement.

16. A method as recited in claim 10, further comprising:
generating notifications for at least one of the consumer entity and one or more of the service groups, the notifications generated based on the resultant allocations of the one or more fulfillable entitlements for the consumer entity.

17. A computer-readable storage memory comprising an entitlement manager stored as instructions that are executable and, responsive to execution of the instructions by a computing device, the computing device performs operations of the entitlement manager comprising to:
associate a consumer entity with purchased entitlements that correspond to products or services purchased by the consumer entity from service groups;
receive provisioning rules that have been designated by the service groups to designate one or more fulfillable entitlements that are associated with the purchased entitlements; and
generate an entitlement model that relates the purchased entitlements of the consumer entity, correlates the one or more fulfillable entitlements for the purchased entitlements, and identifies resultant allocations of the one or more fulfillable entitlements for the consumer entity.

18. The computer-readable storage memory as recited in claim 17, wherein the computing device further performs operations of the entitlement manager comprising to merge similar ones of the fulfillable entitlements that correspond to more than one of the purchased entitlements.

19. The computer-readable storage memory as recited in claim 18, wherein the computing device further performs operations of the entitlement manager to said merge the similar ones of the fulfillable entitlements comprising to:
add the similar fulfillable entitlements;
delete at least one of the similar fulfillable entitlements; or
organize the similar fulfillable entitlements as a single fulfillable entitlement for the consumer entity.

20. The computer-readable storage memory as recited in claim 17, wherein the computing device further performs operations of the entitlement manager comprising to:
receive re-provisioned rules from one of the service groups to alter the one or more fulfillable entitlements that are associated with a purchased entitlement; and
generating an update to the entitlement model for the consumer entity based on the re-provisioned rules.
